(19) United States
(12) Patent Application Publication
(10) Pub. No.: US 2016/0092449 A1
(43) Pub. Date: Mar. 31, 2016

(54) DATA RATING

(71) Applicants: Richard Morrey, Oxfordshire (GB); Guy Roberts, Buckinghamshire (GB); Derek Murphy, Mahon (IE)

(72) Inventors: Richard Morrey, Oxfordshire (GB); Guy Roberts, Buckinghamshire (GB); Derek Murphy, Mahon (IE)

(21) Appl. No.: 14/496,104

(22) Filed: Sep. 25, 2014

(51) Int. Cl. G06F 17/30; H04L 29/06

(52) U.S. Cl. CPC G06F 17/3053; H04L 67/42; H04L 63/1408

(57) ABSTRACT

Particular embodiments described herein provide for an electronic device that can receive, at a rating system, a request for a data rating of data, determine a rating type for the data, receiving rating logic for the rating type, and rate the data using the rating logic. The rating logic for the rating type is included in a dedicated rating database. Also, the rating logic may separate from the rating system and the rating logic can be updated without having to update the rating system.

### TECHNICAL FIELD

This disclosure relates in general to the field of information security, and more particularly, to data rating.

### BACKGROUND

The field of network security has become increasingly important in today's society. The Internet has enabled interconnection of different computer networks all over the world. In particular, the Internet provides a medium for exchanging data between different users connected to different computer networks via various types of client devices. While the use of the Internet has transformed business and personal communications, it has also been used as a vehicle for malicious operators to gain unauthorized access to computers and computer networks and for intentional or inadvertent disclosure of sensitive information.

Malicious software (“malware”) that infects a host computer may be able to perform any number of malicious actions, such as stealing sensitive information from a business or individual associated with the host computer, propagating to other host computers, and/or assisting with distributed denial of service attacks, sending out spam or malicious emails from the host computer, etc. Hence, significant administrative challenges remain for protecting computers and computer networks from malicious and inadvertent exploitation by malicious software.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for a data rating system in accordance with an embodiment of the present disclosure;

FIG. 2 is a simplified flowchart illustrating potential operations that may be associated with the communication system in accordance with an embodiment;

FIG. 3 is a simplified flowchart illustrating potential operations that may be associated with the communication system in accordance with an embodiment;

FIG. 4 is a simplified flowchart illustrating potential operations that may be associated with the communication system in accordance with an embodiment;

FIG. 5 is a simplified flowchart illustrating potential operations that may be associated with the communication system in accordance with an embodiment;

FIG. 6 is a simplified flowchart illustrating potential operations that may be associated with the communication system in accordance with an embodiment;

FIG. 7 is a block diagram illustrating an example computing system that is arranged in a point-to-point configuration in accordance with an embodiment; and

FIG. 8 is a simplified block diagram associated with an example ARM ecosystem system on chip (SOC) of the present disclosure; and

FIG. 9 is a block diagram illustrating an example processor core in accordance with an embodiment.

The FIGURES of the drawings are not necessarily drawn to scale, as their dimensions can be varied considerably without departing from the scope of the present disclosure.

### DETAILED DESCRIPTION OF EXAMPLE EMBODIMENTS

### Example Embodiments

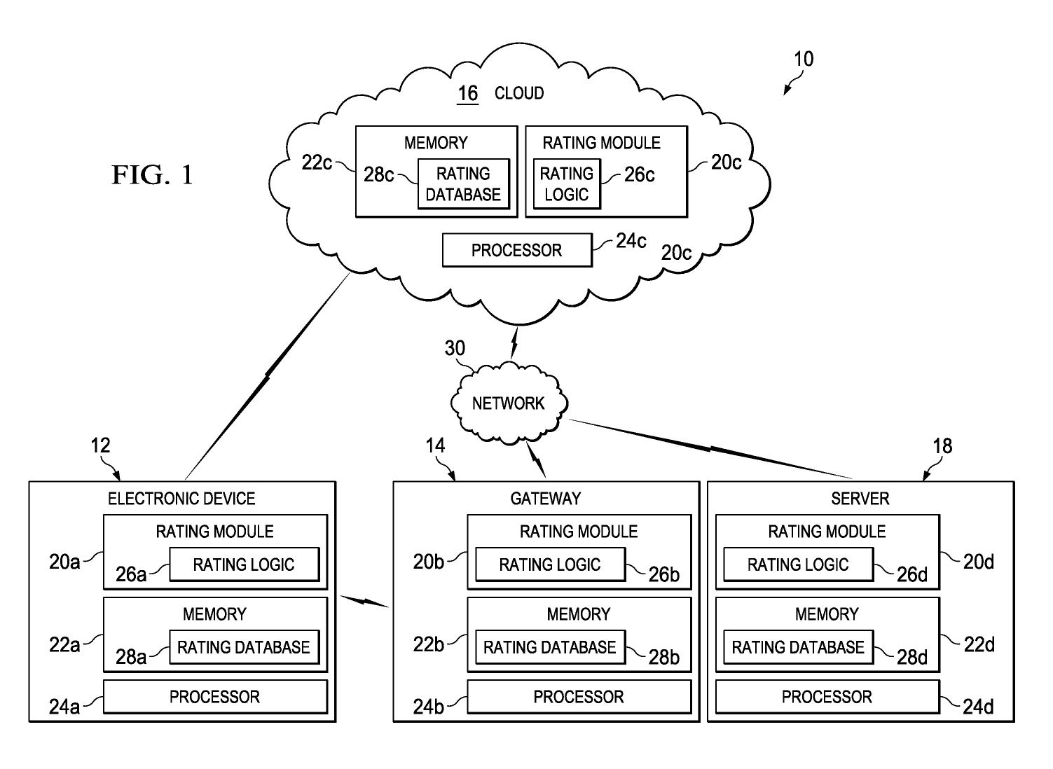

FIG. 1 is a simplified block diagram of a communication system for determining a data rating in accordance with an embodiment of the present disclosure. Communication system 10 can include an electronic device 12, a network gateway 14, a cloud 16, and a server 18 (e.g., a security server). Electronic device 12 can include a rating module 20a, memory 22a, and a processor 24a. Rating module 20a can include data rating logic 26a. Memory 22a can include a rating database 28a. Network gateway 14 can include a rating module 20b, memory 22b, and a processor 24b. Rating module 20b can include data rating logic 26b. Memory 22b can include a rating database 28b. Cloud 16 can include a rating module 20c, memory 22c, and a processor 24c. Rating module 20c can include data rating logic 26c. Memory 22c can include a rating database 28c. Server 18 can include rating module 20d, memory 22d, and a processor 24d. Rating module 20d can include data rating logic 26d. Memory 22d can include a rating database 28d. Electronic device 12, network element 14, cloud 16, and server 18 can be connected through network 30. Electronic device 12 may be connected to network 30 through network gateway 14. Each rating database 28a, 28b, 28c, and 28d can be a dedicated rating database that stores rating variables and the rating logic used by a rating system (e.g,. rating module 20a, 20b 20c, or 20d). The rating variables and the rating logic are separate from the rating system and can be updated without having to update the rating system.

In example embodiments, communication system 10 can be configured to include a system where rating logic used for rating data in a data flow is separate from the rating system that uses the rating logic. Because it is separate from the rating system, the rating logic can be changed or added to without the need to patch or update the rating system. In addition, new rating types can be added to the rating logic by adding a new entry or variable to the rating logic.

Elements of FIG. 1 may be coupled to one another through one or more interfaces employing any suitable connections (wired or wireless), which provide viable pathways for network (e.g., network 30) communications. Additionally, any one or more of these elements of FIG. 1 may be combined or removed from the architecture based on particular configuration needs. Communication system 10 may include a configuration capable of transmission control protocol/Internet protocol (TCP/IP) communications for the transmission or reception of packets in a network. Communication system 10 may also operate in conjunction with a user datagram protocol/IP (UDP/IP) or any other suitable protocol where appropriate and based on particular needs.

For purposes of illustrating certain example techniques of communication system 10, it is important to understand the communications that may be traversing the network environment. The following foundational information may be viewed as a basis from which the present disclosure may be properly explained.

Current security systems calculate/report on the (security) reputation of specific entities encountered on the Internet (e.g., URLs, files, IP addresses, email, etc.) using a rating system. The rating system typically involves a client (e.g., end user) sending a request for a rating of a particular rating type (e.g. URL) together with one or more data values to be used as a basis for the rating. The rating system uses some type of rating logic that interrogates one or more data sets for core reputation values and applies an algorithm or calculation to combine the values into a single rating of the type being requested. Traditionally, the data sets are local to the rating system and hard-coded within the rating system itself.

One problem with this approach is that there is typically one group or team responsible for the ratings and a different group that is responsible for the rating system. This can result in an inter-team dependency for any changes to the rating logic. The inter-team dependency can cause delays and potentially lengthy, high cost engineering cycles that have to be executed by each rating system team in order to modify existing rating logic. The potentially lengthy, high cost engineering cycles typically need to be executed by the group in charge of the rating system in order to deploy any rating logic for new rating types. Further, in the case where a rating system is running on premise, a product patching or updating cycle needs to be executed in order to deploy a change in the rating logic to all the end users. What is needed is a system that can update the rating logic without having to update the rating system.

A communication system for data rating, as outlined in FIG. 1, can resolve these issues (and others). In communication system 10 of FIG. 1, to determine the data rating, the system may be configured to include a system where a dedicated rating logic dataset holds the rating logic for each supported rating type. The entries in the rating logic dataset can be keyed by a rating type. Each entry in the rating logic data set can be a single function that can take as input, a request as sent by an electronic device, have use of an application program interface (API) to interrogate contents of any local dataset, and return a rating of the data. In an example, an electronic device sends a rating request containing a set of data values with one being the name of the rating type required. The rating system can look for an entry with the specified rating type as its key in the rating logic dataset. If an entry in the rating logic dataset exists, the system can retrieve the associated rating logic, execute the logic, and return the outputted rating to the electronic device.

The rating logic is isolated from the rest of the rating system and can be deployed and updated using the same automatic update mechanisms as other data sets of the rating system. This allows the rating team to make changes to the rating logic in the same way they can change other content in the rating system and without the involvement of any other team. Also, the rating logic changes can be tested and deployed in isolation and independent of rating system engineering cycles. Further, new rating types can be added simply by adding a new entry to the rating logic table and independent of the rating system engineering cycles. In addition, rating logic changes and additions can be deployed both in the cloud and on-premise without any system or product patching or updating.

As a use example, to add a Twitter post (Tweet) rating feature based on the reputation of Twitter users and URLs referred to in a Tweet, a new dataset for “TwitterUserReputation” may be added as a new entry to the rating logic dataset with a key such as “Tweet” that would be associated with the appropriate logic to interrogate the URL and twitter user reputation datasets for each URL and user contained within the Tweet. The results could be combined into a single rating based on an appropriate algorithm. Such a system can avoid an engineering cycle and subsequent deployment of a new version of the rating system, which would be required to add in the new example feature.

Turning to the infrastructure of FIG. 1, communication system 10 in accordance with an example embodiment is shown. Generally, communication system 10 can be implemented in any type or topology of networks. Network 30 represents a series of points or nodes of interconnected communication paths for receiving and transmitting packets of information that propagate through communication system 10. Network 30 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication.

In communication system 10, network traffic, which is inclusive of packets, frames, signals, data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Additionally, radio signal communications over a cellular network may also be provided in communication system 10. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

In an example implementation, electronic device 12, network gateway 14, cloud 16, and server 18 are network elements, which are meant to encompass network appliances, servers, routers, switches, gateways, bridges, load balancers, processors, modules, or any other suitable device, component, element, or object operable to exchange information in a network environment. Network elements may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information.

In regards to the internal structure associated with communication system 10, each of electronic device 12, network gateway 14, cloud 16, and server 18 can include memory elements for storing information to be used in the operations outlined herein. Each of electronic device 12, network gateway 14, cloud 16, and server 18 may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in communication system 10 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, network elements of communication system 10, such as electronic device 12, network gateway 14, cloud 16, and server 18 may include software modules (e.g., rating module 20a, 20b, 20c, or 20d respectively) to achieve, or to foster, operations as outlined herein. These modules may be suitably combined in any appropriate manner, which may be based on particular configuration and/or provisioning needs. In example embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, each of electronic device 12, network gateway 14, cloud 16, and server 18 may include a processor (e.g., processor 24a, 24b, 24c, and 24d respectively) that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term ‘processor.’

Electronic device 12 can be a network element and includes, for example, desktop computers, laptop computers, mobile devices, personal digital assistants, smartphones, tablets, or other similar devices. Cloud 16 is configured to provide cloud services to electronic device 12. Cloud services may generally be defined as the use of computing resources that are delivered as a service over a network, such as the Internet. Typically, compute, storage, and network resources are offered in a cloud infrastructure, effectively shifting the workload from a local network to the cloud network. Server 18 can be a network element such as a server or virtual server and can be associated with clients, customers, endpoints, or end users wishing to initiate a communication in communication system 10 via some network (e.g., network 30). The term ‘server’ is inclusive of devices used to serve the requests of clients and/or perform some computational task on behalf of clients within communication system 10. Although rating module 20a is represented as being located in electronic device 12, rating module 20b is represented as being located in network gateway 14, rating module 20c is represented as being located in cloud 16, and rating module 20d is represented as being located in server 18, this is for illustrative purposes only. Each rating module 20a, 20b, 20c, and 20d could be combined or separated in any suitable configuration. Furthermore, each rating module 20a, 20b, 20c, and 20d could be integrated with or distributed in another network.

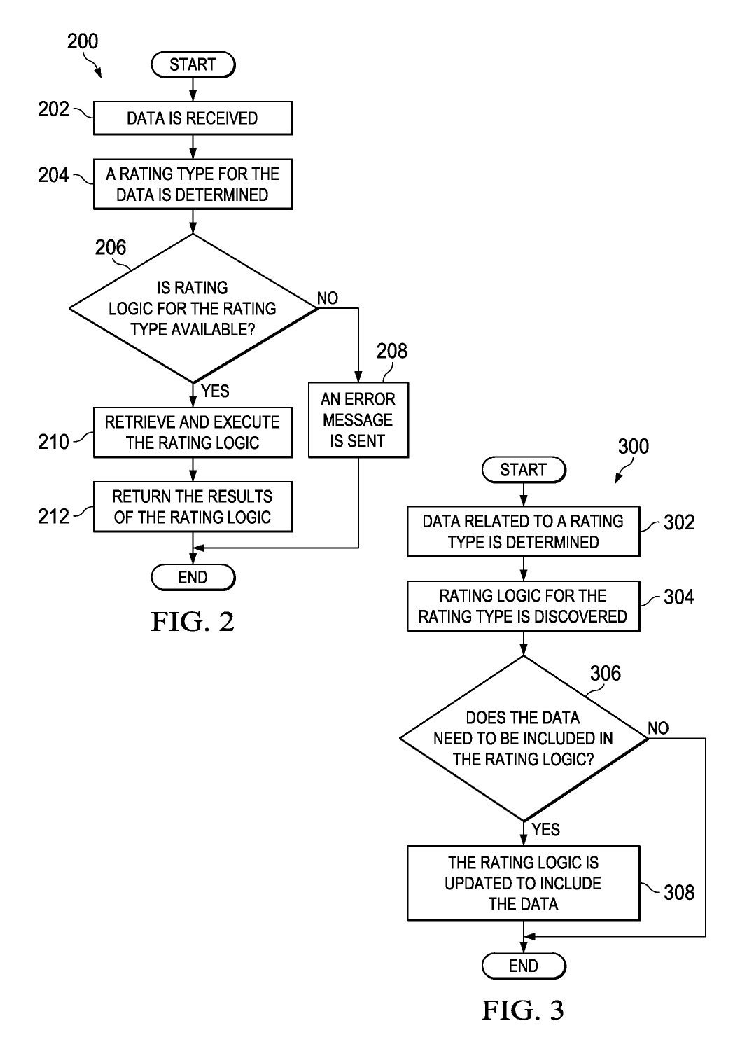

Turning to FIG. 2, FIG. 2 is an example flowchart illustrating possible operations of a flow 200 that may be associated with a data rating system, in accordance with an embodiment. In an embodiment, one or more operations of flow 200 may be performed by one or more of rating module 20a, 20b, 20c, or 20d. At 202, data is received. At 204, a rating type for the data is determined. At 206, the system determines if rating logic for the rating type is available. If rating logic for the rating type is not available, then an error message is sent, as in 208. If rating logic for the rating type is available, then the rating logic is retrieved and executed, as in 210. At 212, the results of the rating logic are returned to the system.

Turning to FIG. 3, FIG. 3 is an example flowchart illustrating possible operations of a flow 300 that may be associated with a data rating system, in accordance with an embodiment. In an embodiment, one or more operations of flow 300 may be performed by one or more of rating module 20a, 20b, 20c, or 20d. At 302, data related to a rating type is determined. At 304, rating logic for the rating type is discovered. At 306, the system determines if the data needs to be included in the rating logic. If the data does need to be included in the rating logic, then the rating logic is updated to include the data, as in 308. If the data does not need to be included in the rating logic, then the process ends. Using this process, rating logic can be easily updated or changed.

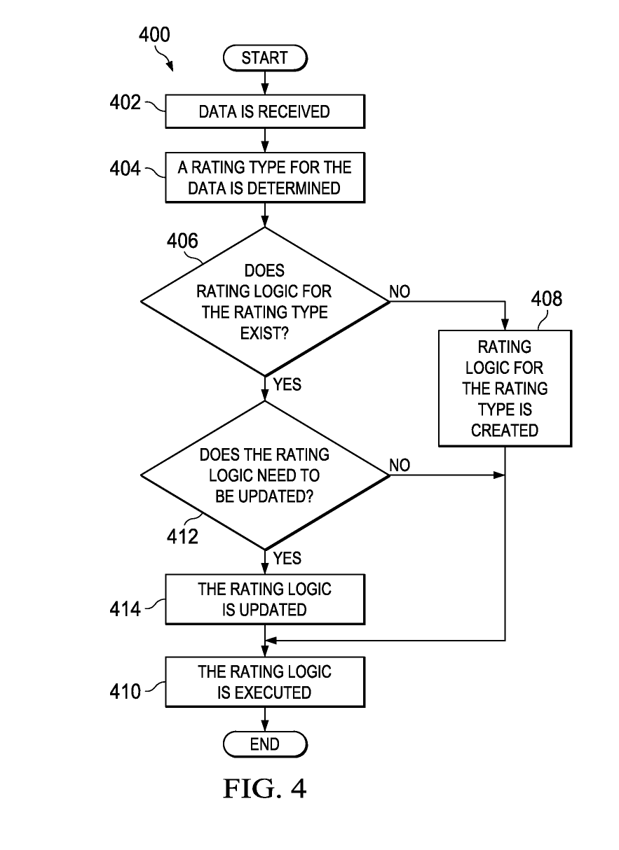

Turning to FIG. 4, FIG. 4 is an example flowchart illustrating possible operations of a flow 400 that may be associated with a data rating system, in accordance with an embodiment. In an embodiment, one or more operations of flow 400 may be performed by one or more of rating module 20a, 20b, 20c, or 20d. At 402, data is received. At 404, a rating type for the data is determined. At 406, the system determines if rating logic for the rating type exists. If rating logic for the rating type does not exist, then rating logic for the rating type is created, as in 408. In an example, if the rating logic for the rating type does not exist, then a request for rating logic for the rating type to be created can be sent to an administrator. If rating logic for the rating type does exist, then the system determines if the rating logic needs to be updated. If the rating logic does not need to be updated, then the rating logic is executed, as in 410. If the rating logic does need to be updated, then the rating logic is updated, as in 414 and the rating logic is executed, as in 410.

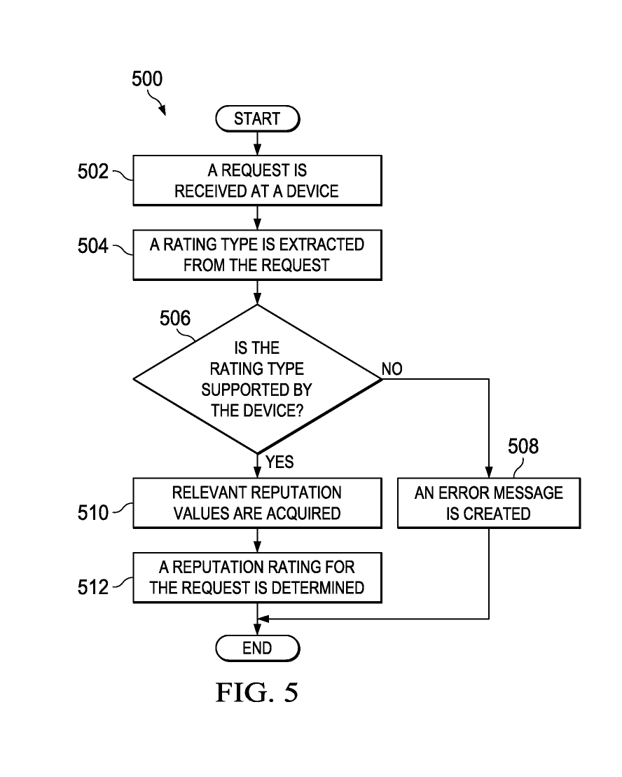

Turning to FIG. 5, FIG. 5 is an example flowchart illustrating possible operations of a flow 500 that may be associated with a data rating system, in accordance with an embodiment. In an embodiment, one or more operations of flow 500 may be performed by one or more of rating module 20a, 20b, 20c, or 20d. At 502, a request is received at a device. At 504, a rating type is extracted from the request. At 506, the system determines if the rating type is supported by the device. If the rating type is not supported by the device, then an error message is created, as in 508. If the rating type is supported by the device, then relevant reputation values are acquired, as in 510. At 512, a reputation rating for the request is determined.

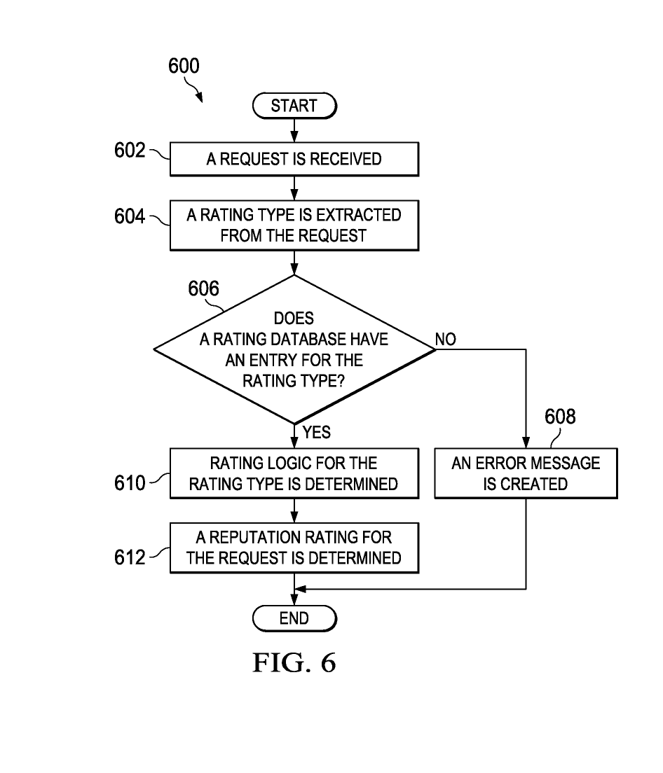

Turning to FIG. 6, FIG. 6 is an example flowchart illustrating possible operations of a flow 600 that may be associated with a data rating system, in accordance with an embodiment. In an embodiment, one or more operations of flow 600 may be performed by one or more of rating module 20a, 20b, 20c, or 20d. At 602, a request is received. At 604, a rating type is extracted from the request. At 606, the system determines if a rating database has an entry for the rating type. If the rating database does not have an entry for the rating type, then an error message is created, as in 608. If the rating database does have an entry for the rating type, then rating logic for the rating type is determined, as in 610. At 612, a reputation rating for the request is determined.

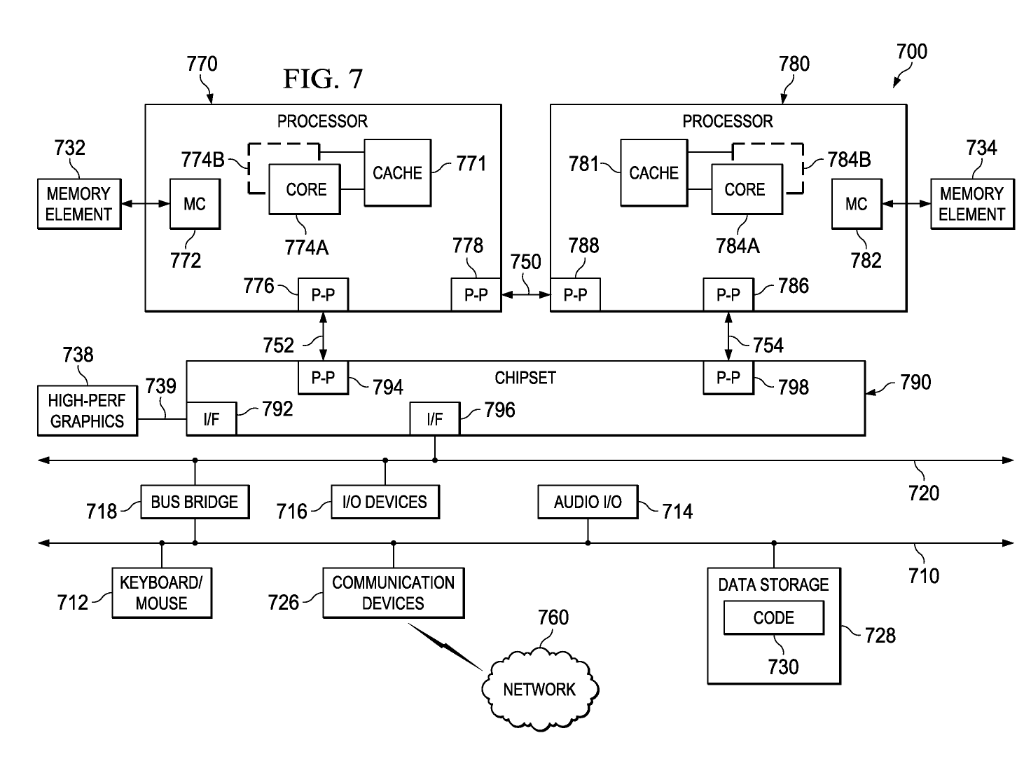

FIG. 7 illustrates a computing system 700 that is arranged in a point-to-point (PtP) configuration according to an embodiment. In particular, FIG. 7 shows a system where processors, memory, and input/output devices are interconnected by a number of point-to-point interfaces. Generally, one or more of the network elements of communication system 10 may be configured in the same or similar manner as computing system 700.

As illustrated in FIG. 7, system 700 may include several processors, of which only two, processors 770 and 780, are shown for clarity. While two processors 770 and 780 are shown, it is to be understood that an embodiment of system 700 may also include only one such processor. Processors 770 and 780 may each include a set of cores (i.e., processor cores 774A and 774B and processor cores 784A and 784B) to execute multiple threads of a program. The cores may be configured to execute instruction code in a manner similar to that discussed above with reference to FIGS. 2-6. Each processor 770, 780 may include at least one shared cache 771, 781. Shared caches 771, 781 may store data (e.g., instructions) that are utilized by one or more components of processors 770, 780, such as processor cores 774 and 784.

Processors 770 and 780 may also each include integrated memory controller logic (MC) 772 and 782 to communicate with memory elements 732 and 734. Memory elements 732 and/or 734 may store various data used by processors 770 and 780. In alternative embodiments, memory controller logic 772 and 782 may be discrete logic separate from processors 770 and 780.

Processors 770 and 780 may be any type of processor, and may exchange data via a point-to-point (PtP) interface 750 using point-to-point interface circuits 778 and 788, respectively. Processors 770 and 780 may each exchange data with a control logic 790 via individual point-to-point interfaces 752 and 754 using point-to-point interface circuits 776, 786, 794, and 798. Control logic 790 may also exchange data with a high-performance graphics circuit 738 via a high-performance graphics interface 739, using an interface circuit 792, which could be a PtP interface circuit. In alternative embodiments, any or all of the PtP links illustrated in FIG. 7 could be implemented as a multi-drop bus rather than a PtP link.

Control logic 790 may be in communication with a bus 720 via an interface circuit 796. Bus 720 may have one or more devices that communicate over it, such as a bus bridge 718 and I/O devices 716. Via a bus 710, bus bridge 718 may be in communication with other devices such as a keyboard/mouse 712 (or other input devices such as a touch screen, trackball, etc.), communication devices 726 (such as modems, network interface devices, or other types of communication devices that may communicate through a computer network 760), audio I/O devices 714, and/or a data storage device 728. Data storage device 728 may store code 730, which may be executed by processors 770 and/or 780. In alternative embodiments, any portions of the bus architectures could be implemented with one or more PtP links.

The computer system depicted in FIG. 7 is a schematic illustration of an embodiment of a computing system that may be utilized to implement various embodiments discussed herein. It will be appreciated that various components of the system depicted in FIG. 7 may be combined in a system-on-a-chip (SoC) architecture or in any other suitable configuration. For example, embodiments disclosed herein can be incorporated into systems including mobile devices such as smart cellular telephones, tablet computers, personal digital assistants, portable gaming devices, etc. It will be appreciated that these mobile devices may be provided with SoC architectures in at least some embodiments.

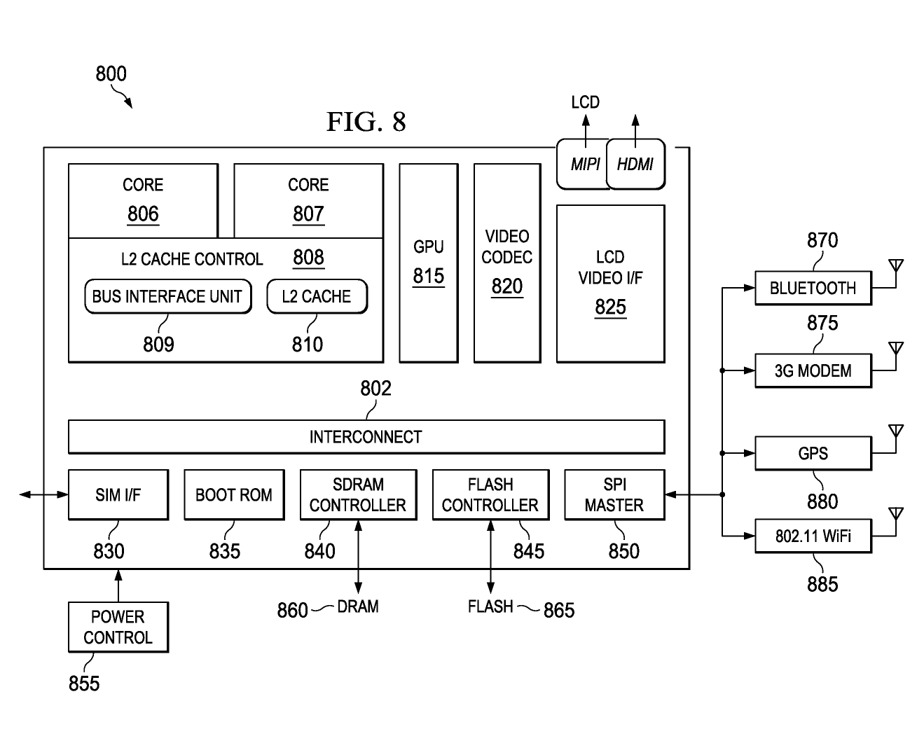

Turning to FIG. 8, FIG. 8 is a simplified block diagram associated with an example ARM ecosystem SOC 800 of the present disclosure. At least one example implementation of the present disclosure can include the data rating features discussed herein and an ARM component. For example, the example of FIG. 8 can be associated with any ARM core (e.g., A-9, A-15, etc.). Further, the architecture can be part of any type of tablet, smartphone (inclusive of Android™ phones, iPhones™, iPad™ Google Nexus™, Microsoft Surfacer™, personal computer, server, video processing components, laptop computer (inclusive of any type of notebook), Ultrabook™ system, any type of touch-enabled input device, etc.

In this example of FIG. 8, ARM ecosystem SOC 800 may include multiple cores 806-807, an L2 cache control 808, a bus interface unit 809, an L2 cache 810, a graphics processing unit (GPU) 815, an interconnect 802, a video codec 820, and a liquid crystal display (LCD) I/F 825, which may be associated with mobile industry processor interface (MIPI)/high-definition multimedia interface (HDMI) links that couple to an LCD.

ARM ecosystem SOC 800 may also include a subscriber identity module (SIM) I/F 830, a boot read-only memory (ROM) 835, a synchronous dynamic random access memory (SDRAM) controller 840, a flash controller 845, a serial peripheral interface (SPI) master 850, a suitable power control 855, a dynamic RAM (DRAM) 860, and flash 865. In addition, one or more embodiments include one or more communication capabilities, interfaces, and features such as instances of Bluetooth™ 870, a 3G modem 875, a global positioning system (GPS) 880, and an 802.11 Wi-Fi 885.

In operation, the example of FIG. 8 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe™ Flash™ Player, Java Platform Standard Edition (Java SE), JavaFX, Linux, Microsoft Windows Embedded, Symbian and Ubuntu, etc.). In at least one embodiment, the core processor may implement an out-of-order superscalar pipeline with a coupled low-latency level-2 cache.

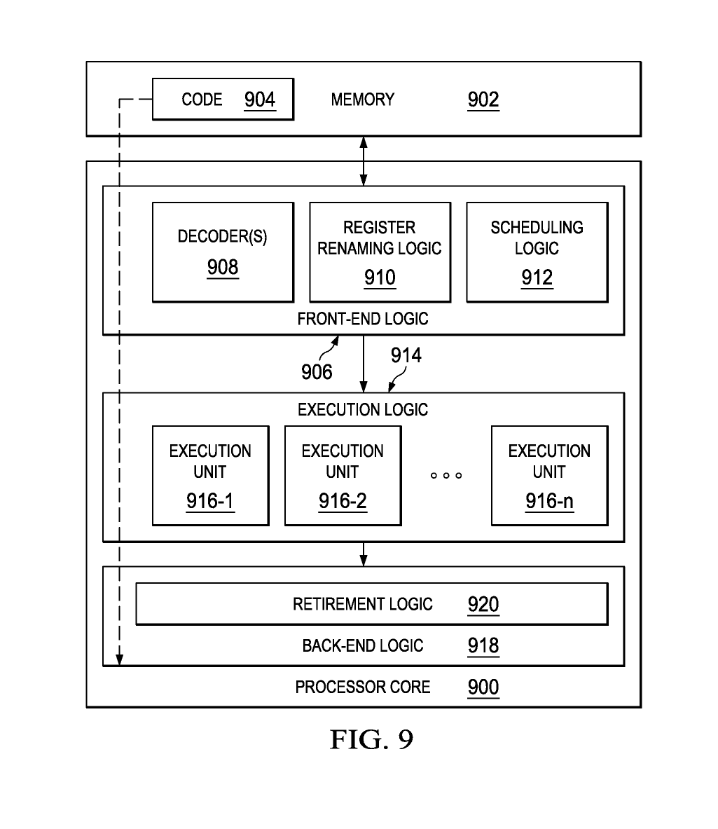

FIG. 9 illustrates a processor core 900 according to an embodiment. Processor core 9 may be the core for any type of processor, such as a micro-processor, an embedded processor, a digital signal processor (DSP), a network processor, or other device to execute code. Although only one processor core 900 is illustrated in FIG. 9, a processor may alternatively include more than one of the processor core 900 illustrated in FIG. 9. For example, processor core 900 represents an embodiment of processors cores 774a, 774b, 784a, and 784b shown and described with reference to processors 770 and 780 of FIG. 7. Processor core 900 may be a single-threaded core or, for at least one embodiment, processor core 900 may be multithreaded in that it may include more than one hardware thread context (or “logical processor”) per core.

FIG. 9 also illustrates a memory 902 coupled to processor core 900 in accordance with an embodiment. Memory 902 may be any of a wide variety of memories (including various layers of memory hierarchy) as are known or otherwise available to those of skill in the art. Memory 902 may include code 904, which may be one or more instructions, to be executed by processor core 900. Processor core 900 can follow a program sequence of instructions indicated by code 904. Each instruction enters a front-end logic 906 and is processed by one or more decoders 908. The decoder may generate, as its output, a micro operation such as a fixed width micro operation in a predefined format, or may generate other instructions, microinstructions, or control signals that reflect the original code instruction. Front-end logic 906 also includes register renaming logic 910 and scheduling logic 912, which generally allocate resources and queue the operation corresponding to the instruction for execution.

Processor core 900 can also include execution logic 914 having a set of execution units 916-1 through 916-N. Some embodiments may include a number of execution units dedicated to specific functions or sets of functions. Other embodiments may include only one execution unit or one execution unit that can perform a particular function. Execution logic 914 performs the operations specified by code instructions.

After completion of execution of the operations specified by the code instructions, back-end logic 918 can retire the instructions of code 904. In one embodiment, processor core 900 allows out of order execution but requires in order retirement of instructions. Retirement logic 920 may take a variety of known forms (e.g., re-order buffers or the like). In this manner, processor core 900 is transformed during execution of code 904, at least in terms of the output generated by the decoder, hardware registers and tables utilized by register renaming logic 910, and any registers (not shown) modified by execution logic 914.

Although not illustrated in FIG. 9, a processor may include other elements on a chip with processor core 900, at least some of which were shown and described herein with reference to FIG. 7. For example, as shown in FIG. 7, a processor may include memory control logic along with processor core 900. The processor may include I/O control logic and/or may include I/O control logic integrated with memory control logic.

Note that with the examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that communication system 10 and its teachings are readily scalable and can accommodate a large number of components, as well as more complicated/sophisticated arrangements and configurations. Accordingly, the examples provided should not limit the scope or inhibit the broad teachings of communication system 10 as potentially applied to a myriad of other architectures.

It is also important to note that the operations in the preceding flow diagrams (i.e., FIGS. 2-6) illustrate only some of the possible correlating scenarios and patterns that may be executed by, or within, communication system 10. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 10 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although communication system 10 has been illustrated with reference to particular elements and operations that facilitate the communication process, these elements and operations may be replaced by any suitable architecture, protocols, and/or processes that achieve the intended functionality of communication system 10.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### Other Notes and Examples

Example C1 is at least one machine readable storage medium having one or more instructions that when executed by at least one processor, cause the at least one processor to receive a request for a rating of data, determine a rating type for the data, receive rating logic for the rating type, and rate the data using the rating logic.

In Example C2, the subject matter of Example C1 can optionally where the rating logic is received from a dedicated rating database.

In Example C3, the subject matter of any one of Examples C1-C2 can optionally include where the request for the rating is received at a rating system and the rating database is separate from the rating system.

In Example C4, the subject matter of any one of Examples C1-C3 can optionally include where the rating logic can be updated without having to update the rating system.

In Example C5, the subject matter of any one of Examples C1-C4 can optionally include where the rating logic is received at a network device, from a different network device.

In Example C6, the subject matter of any one of Example C1-C5 can optionally include where the rating logic is received from a dedicated rating database and new rating logic can be added to the dedicated rating database without having to update the rating system.

In Example C7, the subject matter of any one of Examples C1-C6 can optionally include where the rating logic is received from a cloud.

In Example C8, the subject matter of any one of Examples C1-C7 can optionally include where the rating logic is received from a server.

In Example A1, an apparatus for rating data can include a rating module located in a rating system, where the rating module is configured to receive a request for a rating of data, determine a rating type for the data, receive rating logic for the rating type, and rate the data using the rating logic.

In Example, A2, the subject matter of Example A1 can optionally include where a the rating logic is received from a dedicated rating database.

In Example A3, the subject matter of any one of Examples A1-A2 can optionally include where the rating logic is stored separate from the rating system.

In Example A4, the subject matter of any one of Examples A1-A3 can optionally include where the rating logic can be updated without having to update the rating system.

In Example A5, the subject matter of any one of Examples A1-A4 can optionally include where rating logic is received from a network element that is separate from the rating system.

In Example A6, the subject matter of any one of Examples A1-A5 can optionally include where the rating logic is received from a dedicated rating database and new rating logic can be added to the dedicated rating database without having to update the rating system.

In Example A7, the subject matter of any one of Examples A1-A6 can optionally include where the rating logic is received from a cloud.

In Example A8, the subject matter of any one of Examples A1-A7 can optionally include where the rating logic is received from a server.

Example M1 is a method including receiving, at a rating system, a request for a rating of data, determining a rating type for the data, receiving rating logic for the rating type, and rating the data using the rating logic.

In Example M2, the subject matter of Example M1 can optionally include where the rating logic is received from a dedicated rating database.

In Example M3, the subject matter of any one of the Examples M1-M2 can optionally where the rating logic is separate from the rating system.

In Example M4, the subject matter of any one of the Examples M1-M3 can optionally where the rating logic can be updated without having to update the rating system.

In Example M5, the subject matter of any one of the Examples M1-M4 can optionally include where the rating logic is received from a dedicated rating database and new rating logic can be added to the dedicated rating database without having to update the rating system.

In Example M6, the subject matter of any one of the Examples M1-M5 can optionally include where the rating logic is received from a cloud.

In Example M7, the subject matter of any one of the Examples M1-M6 can optionally include where the rating logic is received from a server.

Example S1 is a rating system for rating data, the system including a rating module configured for receiving a request for a rating of data, determining a rating type for the data, receiving, from a network element separate from the rating system, rating logic for the rating type, and rating the data using the rating logic.

In Example S2, the subject matter of Example S1 can optionally include where the rating logic is received from a dedicated rating database and the rating logic can be updated without having to update the rating system.

Example X1 is a machine-readable storage medium including machine-readable instructions to implement a method or realize an apparatus as in any one of the Examples A1-A8, or M1-M7. Example Y1 is an apparatus comprising means for performing of any of the Example methods M1-M7. In Example Y2, the subject matter of Example Y1 can optionally include the means for performing the method comprising a processor and a memory. In Example Y3, the subject matter of Example Y2 can optionally include the memory comprising machine-readable instructions.

What is claimed is:

1. At least one computer-readable medium comprising one or more instructions that when executed by at least one processor:
receive a request for a rating of data;
determine a rating type for the data;
receive rating logic for the rating type; and
rate the data using the rating logic.

2. The at least one computer-readable medium of claim 1, wherein the rating logic is received from a dedicated rating database.

3. The at least one computer-readable medium of claim 2, wherein the request for the rating is received at a rating system and the rating database is separate from the rating system.

4. The at least one computer-readable medium of claim 3, wherein the rating logic can be updated without having to update the rating system.

5. The at least one computer-readable medium of claim 1, wherein the rating logic is received at a network device, from a different network device.

6. The at least one computer-readable medium of claim 1, wherein the rating logic is received from a dedicated rating database and new rating logic can be added to the dedicated rating database without having to update the rating system.

7. The at least one computer-readable medium of claim 1, wherein the rating logic is received from a cloud.

8. The at least one computer-readable medium of claim 1, wherein the rating logic is received from a server.

9. An apparatus for rating data, the apparatus comprising:
a rating module located in a rating system, the rating module configured to:
receive a request for a rating of data;
determine a rating type for the data;
receive rating logic for the rating type; and
rate the data using the rating logic.

10. The apparatus of claim 9, wherein the rating logic is received from a dedicated rating database.

11. The apparatus of claim 9, wherein the rating logic is stored separate from the rating system.

12. The apparatus of claim 9, wherein the rating logic can be updated without having to update the rating system.

13. The apparatus of claim 9, wherein rating logic is received from a network element that is separate from the rating system.

14. The apparatus of claim 9, wherein the rating logic is received from a dedicated rating database and new rating logic can be added to the dedicated rating database without having to update the rating system.

15. The apparatus of claim 9, wherein the rating logic is received from a cloud.

16. The apparatus of claim 9, wherein the rating logic is received from a server.

17. A method comprising:
receiving, at a rating system, a request for a rating of data;
determining a rating type for the data;
receiving rating logic for the rating type; and
rating the data using the rating logic.

18. The method of claim 17, wherein the rating logic is received from a dedicated rating database.

19. The method of claim 17, wherein the rating logic is separate from the rating system.

20. The method of claim 17, wherein the rating logic can be updated without having to update the rating system.

21. The method of claim 17, wherein the rating logic is received from a dedicated rating database and new rating logic can be added to the dedicated rating database without having to update the rating system.

22. The method of claim 17, wherein the rating logic is received from a cloud.

23. The method of claim 22, wherein the rating logic is received from a server.

24. A rating system for rating data, the system comprising:
a rating module configured for:
receiving a request for a rating of data;
determining a rating type for the data;
receiving, from a network element separate from the rating system, rating logic for the rating type; and
rating the data using the rating logic.

25. The system of claim 24, wherein the rating logic is received from a dedicated rating database and the rating logic can be updated without having to update the rating system.
